(19) United States
(12) Patent Application Publication
(10) Pub. No.: US 2011/0156328 A1
(43) Pub. Date: Jun. 30, 2011

(54) INTEGRAL RETAINER TO RETAIN A SPRING

(76) Inventors: Curtis J. Nicolio, Mayfield, PA (US); Ronald A. Zaykoski, Nanticoke, PA (US)

(21) Appl. No.: 12/650,584

(22) Filed: Dec. 31, 2009

(51) Int. Cl. F16F 1/10; B21F 35/00

(52) U.S. Cl. 267/156; 29/896.9

(57) ABSTRACT

A power, motor, or clock spring featuring an integral retainer that prevents the spring from returning to its relaxed state. The integral retainer includes at least two of the coils of the spring being bonded together either through direct bond or via a welding material. The formation of an integral retainer in which the bonded coils of the spring itself acts as the retainer, creates a power spring that is easier and safer to handle and less expensive to create. The bond can be located only at the outermost point of the spring bonding the two outermost coils together adjacent an outer hook of the power spring.

### FIELD

The present disclosure relates to a spring and the method of making the spring. The spring includes springs known as power, motor, or clock springs used to store and deliver energy to recoil an elongated windable article, retained in a wound state by an integral retainer.

### BACKGROUND

In the discussion of the background that follows, reference is made to certain structures and/or methods. However, the following references should not be construed as an admission that these structures and/or methods constitute prior art. Applicant expressly reserves the right to demonstrate that such structures and/or methods do not qualify as prior art.

Power springs are used in various end products to store and deliver energy in the form of torque and turns. Power springs are typically used in products that include recoiling of elongated cords, wires, hoses, and belts including the pull start cord on lawn mowers, chain saws, weed trimmers, and numerous other lawn and garden and outdoor equipment. Power springs are also used to recoil seat belts.

Power springs store and deliver energy by connecting an inner hook of a spring to an axial post and an outer hook of a spring to a barrel, wherein at least the post or the barrel rotates in relation to the other. To be able to wind the spring into a diameter sufficient for use in the intended product, power springs are pre-wound by a machine, and a mechanism is applied to prevent the spring from returning to its relaxed state.

The mechanism typically used to prevent the spring from returning to its relaxed state is rigid and strong enough to overcome the natural uncoiling forces of the spring. Also, the retaining device usually wraps completely around the spring so as to evenly distribute the restraining forces.

Existing retaining methods include an additional product wrapped around the spring to prevent the spring from expanding or uncoiling beyond the circumference of the additional product. Examples of these retaining methods are shown in FIGS. 1-2.

FIG. 1 shows a commercially available retaining method using a sheet metal lock washer 20 to retain a power spring 10 containing an outer hook 12 and inner hook 14. The sheet metal lock washer 20 is a rigid material with a hole in the middle in which a power spring 10 is positioned. Because of the rigidity of the sheet metal lock washer 20, the spring is prevented from expanding back to its relaxed state. Further, the sheet metal lock washer 20 includes a locking slot 22 for the outer hook 12 of the power spring to rest, and to prevent the outermost coil of the power spring 10 from rotating. Therefore, the sheet metal lock washer 20 often times must be removed from the power spring 10 before transferring the power spring 10 to the product in which the power spring 10 will be used.

FIG. 2 shows another commercially available retaining method using a spot welded or riveted band 24 to wrap around a power spring 10 containing an outer hook 12 and inner hook 14. The spot welded or riveted band 24 is formed of a sheet material, and contains a weld or rivet strong enough to prevent a power spring from expanding back to its relaxed state. The spot welded or riveted band 24 further wraps around the outer hook 12. Therefore, the spot welded or riveted band 24 often times must be removed from the power spring 10 before transferring the power spring to the product in which the power spring 10 will be used.

Examples of spring retainers are shown in U.S. Pat. Nos. 3,625,502 and 4,881,621. However, none of these prior art solutions are integral spring retainers. Each solution requires an additional component added to a power spring that adds expense. Also, any of these prior art solutions have the potential of being separated from the spring during transport and storage and/or are required to be separated during transfer to the product in which the power spring is used.

When the mechanism for retaining the spring is an external additional component, as described in the prior art, the spring often times must be separated from the retainer and transferred to the relatively movable parts of the device in which it is used. Any escape from the retainer during the initial installation of the spring in the mechanism, during transportation and handling before installing on the device in which it is used, or during installation of the spring in the device in which it is used is a bodily hazard to people handling the spring. Further, if a spring becomes unwound it must be either rewound and retained resulting in further expense, or more often than not, scrapped for another wound spring.

### SUMMARY

To improve the functionality, safety aspects, and production expenses, a new method of using an integral retainer for the spring was developed. An integral retainer as described can eliminate the concern of the spring and retainer being separated, and the additional cost of producing and assembling separate articles during the formation of a power spring without sacrificing the functionality of the power spring.

An exemplary spring comprises a spring tempered material wound to form a plurality of coils, wherein at least two of the coils are bonded together to form an integral retainer that prevents the spring tempered material from returning to its relaxed state.

An exemplary method of making a retained spring comprises the steps of winding spring tempered material to form a plurality of coils and bonding at least two of the coils together to form an integral retainer that prevents the spring tempered material from returning to its relaxed state.

It is to be understood that both the foregoing general description and the following detailed description are exemplary and explanatory and are intended to provide further explanation of the invention as claimed.

### BRIEF DESCRIPTION OF THE DRAWING

The following detailed description can be read in connection with the accompanying drawings in which like numerals designate like elements and in which:

FIG. 1 illustrates a prior art power spring containing a sheet metal lock washer as the retainer.

FIG. 2 illustrates another prior art power spring containing a spot welded or riveted band as the retainer.

FIG. 3 shows a top view of a first exemplary embodiment of a power spring containing an integral retainer.

FIG. 4 shows a partial top view of area A in FIG. 3.

FIG. 5 shows a partial top view of an area similar to area A in FIG. 3 for a second exemplary embodiment of a power spring containing an integral retainer.

FIG. 6 shows a top view of a third exemplary embodiment of a power spring containing an integral retainer.

FIG. 7 shows a partial top view of area B in FIG. 6.

FIG. 8 shows a partial top view of an area similar to area B in FIG. 6 for a fourth exemplary embodiment of a power spring containing an integral retainer.

FIG. 9 shows a top view of a fifth exemplary embodiment of a power spring containing an integral retainer.

FIG. 10 shows a partial top view of area C in FIG. 9.

FIG. 11 shows a top view of a sixth exemplary embodiment of a power spring containing an integral retainer.

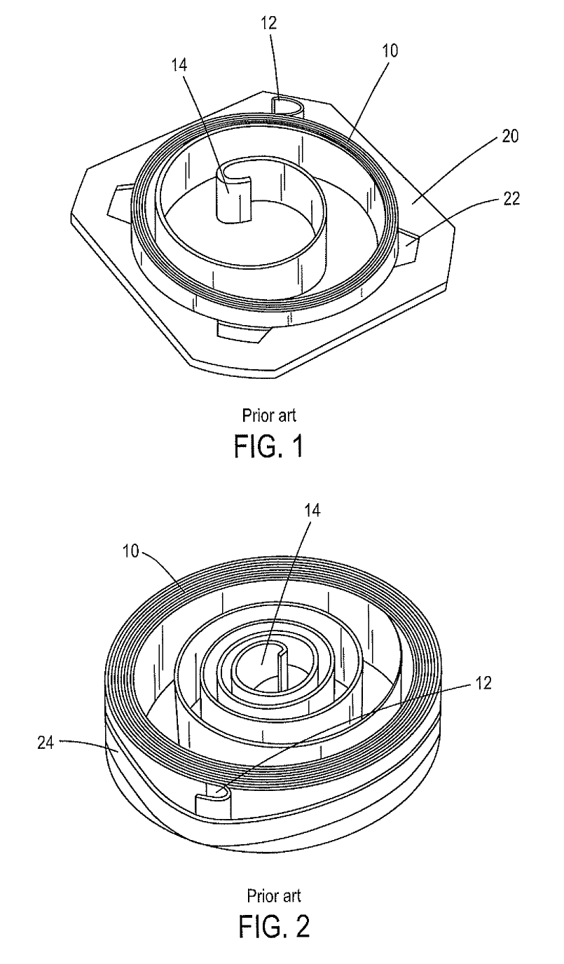

### DETAILED DESCRIPTION

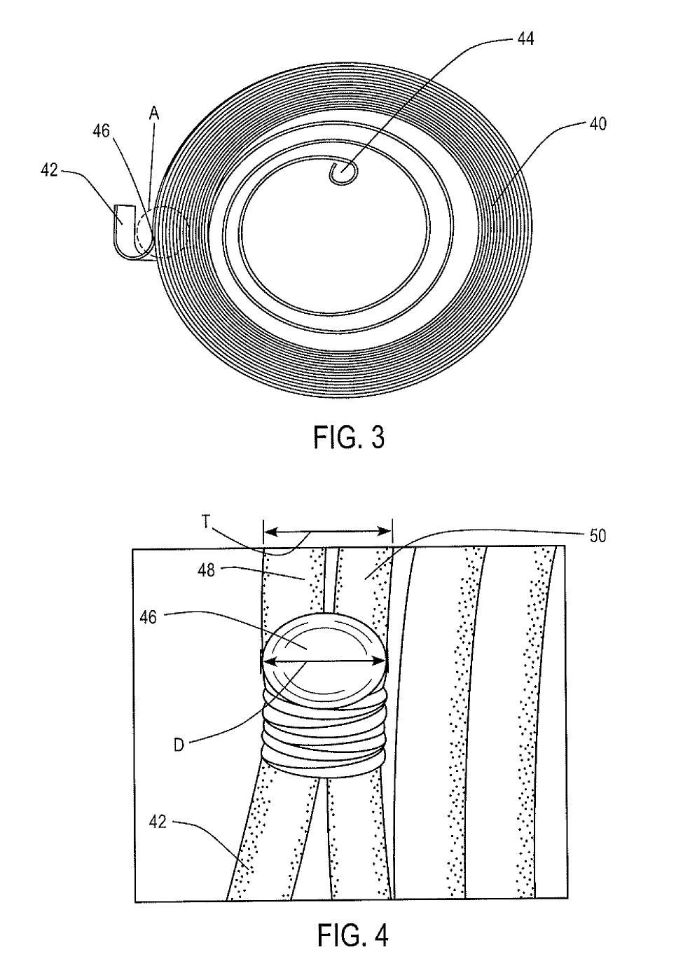

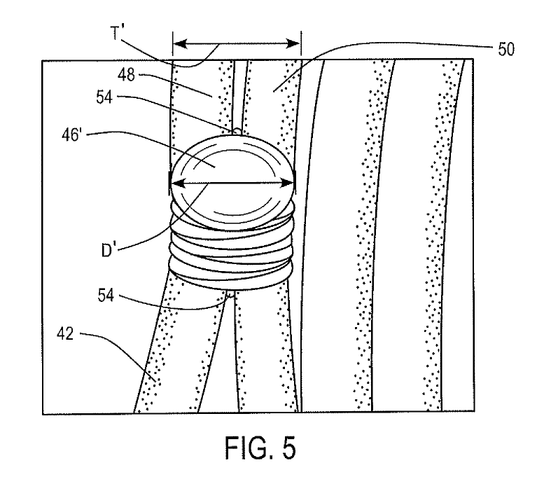

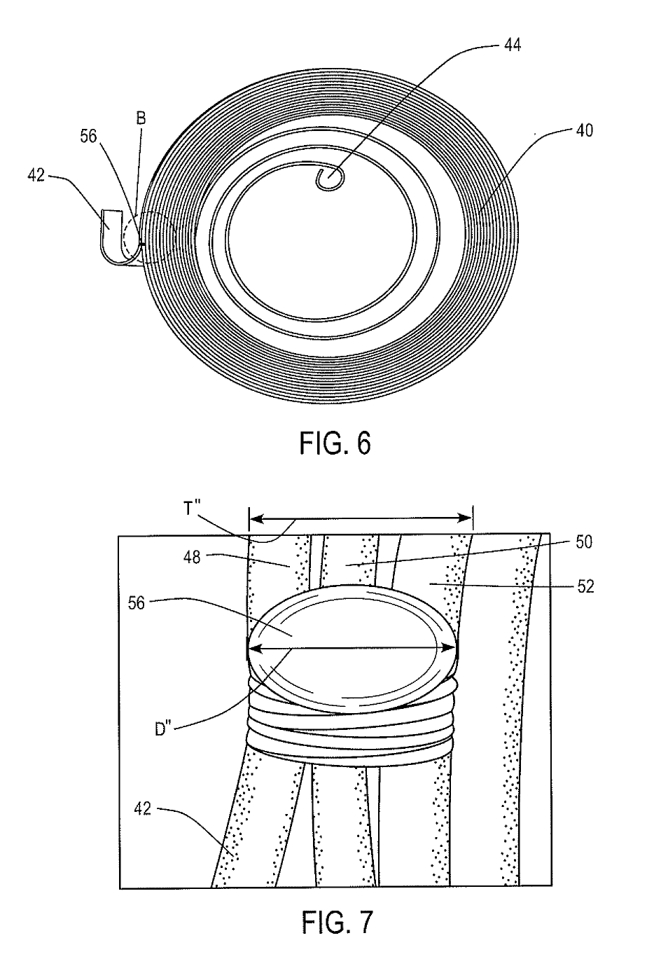

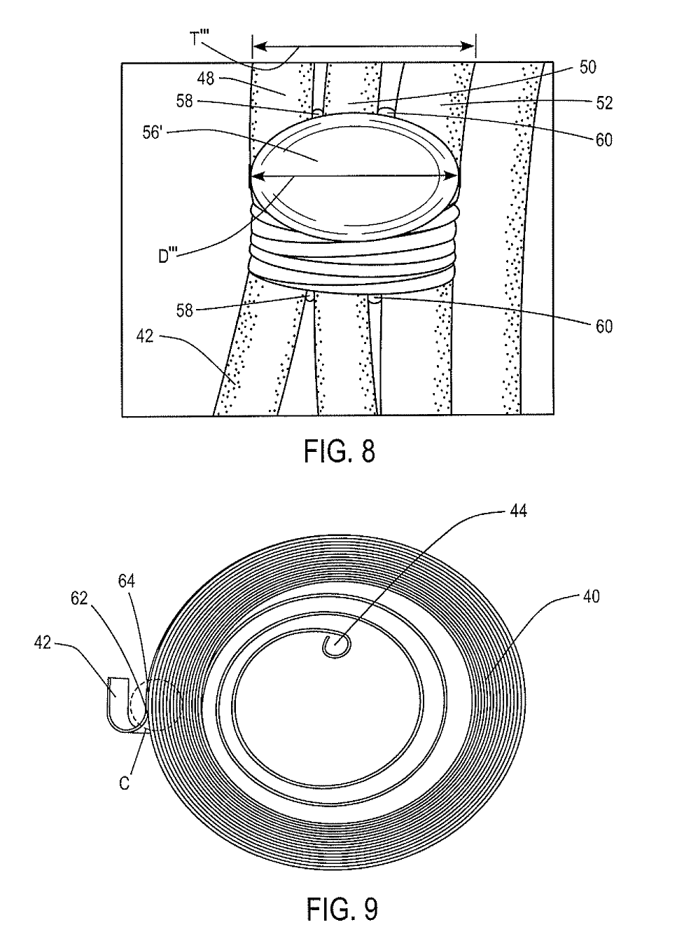

A first exemplary embodiment of a power spring containing an integral retainer is shown in FIGS. 3 and 4. The power spring 40 is formed of spring tempered material wound to form a plurality of coils. The spring tempered material includes high strength strip steel or high strength flat rolled wire. In particular, the spring tempered material can include mid-high carbon-manganese spring steel. The power spring 40 further includes an outer hook 42 and inner hook 44 to attach to corresponding elements in the product in which the power spring is used. The integral retainer has sufficient strength to prevent the wound strip material from returning to its relaxed state.

Power springs are used to store and transmit energy through the use of torque and turns to recoil other products. In particular, power springs are used for pull start cords on lawn mowers, chain saws, weed trimmers, and numerous other lawn and garden and outdoor power equipment, as well as used to recoil seat belts. Power springs can also be used to recoil much larger elongated windable elements requiring even greater levels of torque. Power springs require retainers capable of preventing the highly wound springs from returning to a relaxed state.

An embodiment of an integral retainer according to the invention includes bonding at least two of the coils together so that the spring itself forms the integral retainer. By utilizing the spring itself as the integral retainer, the production of the retained power spring is easier and less expensive. The integral retainer of the invention does not require production of separate products such as rings, and does not require the separate process steps of aligning and attaching the separate retainer to the power spring. An embodiment of a method for forming the retained spring includes the steps of winding spring tempered material to form a plurality of coils and bonding at least two of the coils together to form an integral retainer that prevents the spring tempered material from returning to its relaxed state.

The at least two coils are bonded by any known method. In at least one embodiment, the at least two coils are metallurgically joined. The metallurgical joining of the coils can be achieved either by directly adhering the coils to each other at an interface or joining the coils by a welding material.

As seen in FIGS. 3-5, the integral retainer can be formed by bonding only two coils. In particular, the two coils selected for bonding are the two outermost coils 48, 50 of the spring. By bonding only the two outermost coils the rest of the coils can separate from each other as the spring is tightened, which increases the amount of stored energy that can be delivered as the spring is allowed to relax. As illustrated in FIGS. 3-5, the two outermost coils 48, 50 are bonded at a location adjacent the outer hook 42 of the spring at the outermost point of the winding. By forming the integral retainer adjacent the outer hook so that the outer hook remains exterior to the integral retainer, the power spring can be transferred directly to the product to which it is used, and there is no point during the transfer in which the spring is separated from the retainer.

As seen in FIG. 4, at the interface in an embodiment of directly adhering the coils 48, 50 at a weld spot 46, at least a part of the at least two coils become at least partially intermingled. In other embodiments, the at least two coils 48, 50 are fully intermingled at the interface. The bond can be formed by laser welding and the interface can include one spot pulse or a number of laser pulses that each modifies the structure of the previous weld as illustrated in FIG. 4. When multiple laser pulses are used in a single location, the seam can be welded away from the hook or towards the hook. FIG. 4 illustrates the seam being welded away from the hook.

The at least partial intermingling of the at least two coils is achieved by heating the interface. In particular, the coils are heated above the melting temperature of the coils to allow the coils to flow into each other at the interface. Some exemplary methods of heating the interface of the coils to facilitate intermingling of the at least two coils include resistance welding, spot welding, laser welding, and electron beam welding. The diameter (D) of the weld spot 46 is less than or equal to the thickness (T) of the combination of coils 48, 50 bonded to form the integral retainer. This ensures that the bond only prevents the intended coils from separating from each other, which allows the spring to be wound tighter and to spring back to its integrally retained state faster when the winding force is relaxed.

In FIG. 5, the coils 48, 50 are joined by a welding material 54, a first coil 48 is joined to a first portion of a welding material 54, and a second coil 50 is joined to a second portion of the welding material 54 at the weld spot 46′. The welding material can include any material typically used in welding steel. Exemplary welding material includes steel or titanium. Exemplary methods of bonding utilizing a welding material include metal arc welding, metal inert gas welding, or titanium inert gas welding. The diameter (D′) of the weld spot 46′ is less than or equal to the thickness (T′) of the combination of coils 48, 50 and the intervening welding material 54 bonded to form the integral retainer. This ensures that the bond only prevents the intended coils from separating from each other, which allows the spring to be wound tighter and to spring back to its integrally retained state faster when the winding force is relaxed.

In other embodiments illustrated by FIGS. 6-8, more than two coils are joined. In particular, FIGS. 6-8 illustrate an embodiment in which three coils are joined. However, more than three coils can be joined by similar methods. More than two coils can be joined by either direct intermingling of the coils at the interfaces or by use of a welding material as described in detail above for joining two coils.

In embodiments where more than two coils are joined by direct intermingling of the coils at the interface, each set of two coils can be joined separately in the manner described above, or each of the coils to be joined can be heated simultaneously to allow intermingling of each of the coils to form substantially one material. An exemplary embodiment of simultaneously intermingling more than two coils at once is illustrated in FIG. 7. In a specific embodiment, adjacent coils 48, 50, 52 to be joined are heated above the melting temperature of the coils such that the adjacent coils intermingle before cooling. Such an intermingling of adjacent coils is exemplified by the weld spot 56 in FIG. 7, which illustrates intermingling of the three adjacent coils 48, 50, 52. Bonding more than two coils simultaneously can be useful when it is desired to have a thicker bond. A thicker bond can be useful for either making the bond stronger, or to make the bond easier to create because less precision is required when bonding a larger target. The diameter (D″) of the weld spot 56 is less than or equal to the thickness (T″) of the combination of coils 48, 50, 52 bonded to form the integral retainer. This ensures that the bond only prevents the intended coils from separating from each other, which allows the spring to be wound tighter and to spring back to its integrally retained state faster when the winding force is relaxed.

In other embodiments it is beneficial to make separate bonds between each set of two coils within the number of coils desired to join together. In an exemplary embodiment of joining three coils by two separate bonds, the two coils are bonded together using a method described above for bonding two coils, and then the third coil is bonded to one of the other two coils in a separate bonding step similar to the first. By bonding the three coils with two separate bonds, the spring is provided with a second integral retainer in case the first integral retainer fails.

In embodiments in which more than two coils are joined using welding material, the welding material is placed between each set of two coils that are to be joined. FIG. 8 illustrates the use of welding material 58, 60 to join three coils 48, 50, 52 at a weld spot 56′. Such a bond is formed by, for example, joining a first coil 48 to a first portion of a first welding material 58; a first surface of a second coil 50 is joined to a second portion of the first welding material 58 and the second surface opposite the first surface of the second coil 50 is joined to a first portion of the second welding material 60; and a third coil 52 is joined to a second portion of the second welding material 60. The diameter (D′″) of the weld spot 56′ is less than or equal to the thickness (T′″) of the combination of coils 48, 50, 52 and the intervening welding material 58, 60 bonded to form the integral retainer. This ensures that the bond only prevents the intended coils from separating from each other, which allows the spring to be wound tighter and to spring back to its integrally retained state faster when the winding force is relaxed.

In certain embodiments, the thickness of individual coils can be less than about 2.5 mm. In more certain embodiments, the thickness of individual coils can be less than about 1 mm. In yet more certain embodiments, the thickness of individual coils can be less than about 0.5 mm. In a particular embodiment, the thickness of the two outermost coils combined is about 1 mm, and the diameter of the weld spot joining the two outermost coils is about 0.75 mm. In some embodiments, the weld spot can have a diameter, for example, less than about 10 mm, less than about 5 mm, or less than about 2 mm.

Further, the coils can be bonded at one single location or at multiple locations to form the integral retainer. A single location allows the spring to be wound tighter for reasons similar to only bonding the two outermost coils of the spring, but multiple locations provide additional retention in the event one of the bonds fails. In one embodiment, the single location is adjacent the outer hook of the spring located at the outermost point of the winding.

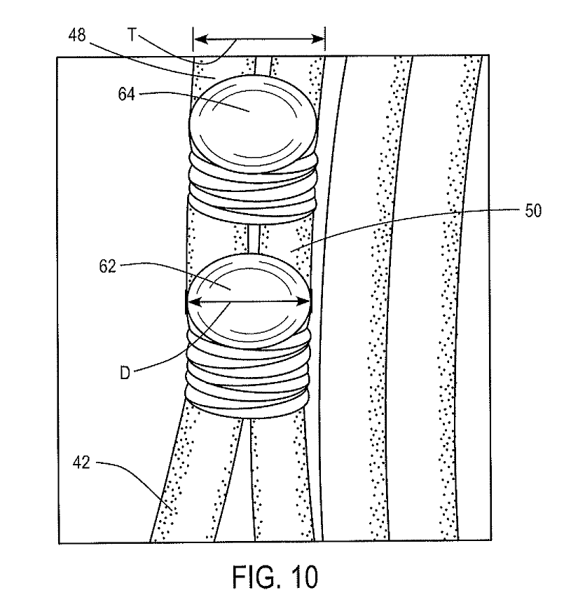

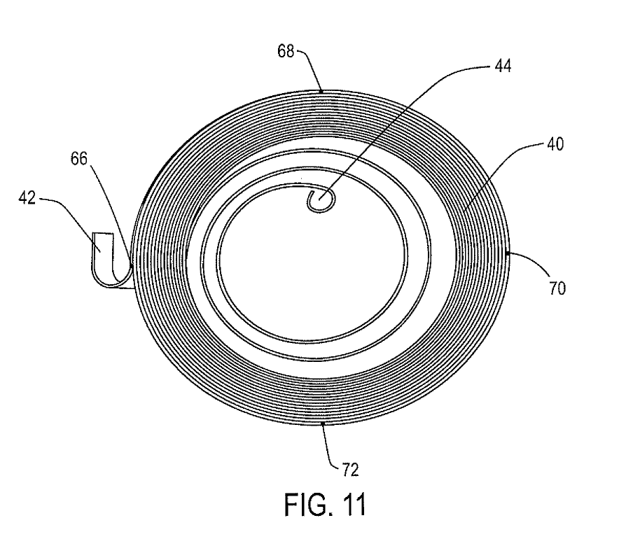

Joining the coils at multiple locations is illustrated in FIGS. 9-11. Specifically, FIGS. 9-10 illustrate an embodiment in which the two outermost coils 48, 50 are bonded at two similar weld spots 62, 64 that are each located in close proximity to the outer hook 42. This embodiment provides an additional weld spot in case one fails while still maximizing how tightly the spring can be wound. FIG. 11 illustrates an embodiment in which the two outermost coils 48, 50 are bonded at four weld spots 66, 68, 70, 72 distributed evenly around the wound spring. This embodiment provides four completely separate locations for bonding as additional retention in the event one of the bonds fails.

In an exemplary embodiment, the at least two coils are joined by laser welding. If desired, the coil can be laser welded in more than one location on the spring, and the laser weld can weld more than two coils together in one location. In some embodiments, especially where the power, motor, or clock spring is small and/or where the thickness of the individual coils of the power, motor, or clock spring is small. For example, power, motor or clock springs with individual coils can have a thickness of less than about 1 mm.

Laser welding techniques are sometimes preferred for preparing integral retainers on small coils. Laser welding can be preferred because, for example, gas welding is done with a flame from a burning gas to create the welding heat needed. An oxyacetylene torch is the most universal type with a very hot flame. However, for bonding the coils having small thicknesses discussed above, the flame cannot be made small or precise enough to perform the weld and would risk overheating the areas surrounding the weld spot. Resistance welding creates coalescence of the work piece at the point where the electrode makes contact by passing a current through the work piece. This technology is complex based on the electrode design and the limited space for integrating it into existing equipment or for contacting the two outermost coils of the spring. Arc welding creates the heat through the use of an electric arc either AC or DC. This technology uses a filler material either a wire or stick which could be incompatible with the spring material. TIG welding can be done without a filler but this technology also causes large heating zones.

Spot welding is able to form smaller weld spots than many of the other techniques, but can still result in super heated areas around the weld and large weld spots. Therefore, for at least some springs containing small coil thicknesses, laser welding is used to avoid large weld spots and overheating of the areas around the weld.

The number of coils bonded together and the area of the bond created is inversely proportional to the number of turns that can be applied to the spring during use. Therefore, it can be preferred to limit the number of coils bonded together to only the two outermost coils. The small thickness of individual coils and the desire to limit the number of coils bonded by the welding step can make the welding step difficult.

Applicants have discovered that laser welding is an effective method of accomplishing the desired weld of only the two outermost coils. The laser welding step utilizes a laser having sufficient size and intensity to effectively weld the selected material forming the spring with a diameter that is less than or equal to the thickness of the two outermost coils.

The power springs having an integral retainer are installed in the products to which it will be used, without the added and potentially hazardous step of separating the spring from its retainer before installing it in the product. The integral retainer remains an integral component of the power spring throughout the life of the spring, including during storage, transportation, and installation of the spring in the product to which it is used.

Although described in connection with preferred embodiments thereof, it will be appreciated by those skilled in the art that additions, deletions, modifications, and substitutions not specifically described may be made without departure from the spirit and scope of the invention as defined in the appended claims.

What is claimed is:

1. A spring comprising a spring tempered material wound to form a plurality of coils, wherein at least two of the coils are metallurgically joined together to form a bond forming an integral retainer that prevents the spring tempered material from returning to its relaxed state.

2. The spring according to claim 1, wherein the at least two metallurgically joined coils adhere directly to each other at an interface.

3. The spring according to claim 2, wherein at the interface at least part of the at least two coils are at least partially intermingled.

4. The spring according to claim 2, wherein the at least two metallurgically joined coils are laser welded to each other at an interface.

5. The spring according to claim 1, wherein the metallurgically joined coils are joined by a welding material.

6. The spring according to claim 5, wherein a first metallurgically joined coil is joined to a first portion of the welding material and a second metallurgically joined coil is joined to a second portion of the welding material.

7. The spring according to claim 6, wherein the welding material includes steel or titanium.

8. The spring according to claim 1, wherein the diameter of the bond is less than about 5 mm.

9. The spring according to claim 1, wherein the diameter of the bond is less than or equal to the thickness of the combination of the bonded coils and any intervening welding material.

10. The spring according to claim 9, wherein the thickness of each of the metallurgically joined coils is less than about 2 mm.

11. The spring according to claim 9, wherein the thickness of the two outermost coils combined is about 1 mm, and the diameter of the bond is about 0.75 mm.

12. The spring according to claim 1, wherein the integral retainer includes only two outermost coils of the spring bonded together.

13. The spring according to claim 1, wherein the spring tempered material includes an outer hook at an end of the spring tempered material located at an outermost point of the winding and wherein the two outermost coils are bonded adjacent the, outer hook.

14. A method of forming a retained spring comprising the steps of:
winding spring tempered material to form a plurality of coils, and
metallurgically joining at least two of the coils together to form an integral retainer that prevents the spring tempered material from returning to its relaxed state.

15. The method according to claim 14, wherein the bonding step includes direct metallurgical joining of the at least two coils.

16. The method according to claim 15, wherein the bonding step includes laser welding the at least two coils.

17. The method according to claim 14, wherein the bonding step includes metallurgical joining each of the at least two coils to a welding material.

18. The method according to claim 17, wherein the metallurgical joining step includes joining a first coil to a first portion of the welding material and a second coil to a second portion of the welding material.

19. The method according to claim 14, wherein the bonding step forms a bond having a diameter less than or equal to the thickness of two coils.

20. The method according to claim 14, wherein the bonding step includes joining the two outermost coils of the spring.
